(19) United States
(12) Patent Application Publication
(10) Pub. No.: US 2009/0032738 A1
(43) Pub. Date: Feb. 5, 2009

(54) CHARGED PARTICLE BEAM WRITING APPARATUS AND METHOD THEREOF

(75) Inventor: Hidekazu TAKEKOSHI, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: NuFlare Technology, Inc., Numazu-shi (JP)

(21) Appl. No.: 12/163,015

(22) Filed: Jun. 27, 2008

(30) Foreign Application Priority Data
Jul. 31, 2007 (JP) 2007-198331

(51) Int. Cl. G21K 5/10

(52) U.S. Cl. 250/492.22

(57) ABSTRACT

A charged particle beam writing apparatus includes a dividing unit configured to virtually divide a writing region of a target workpiece into a plurality of small regions along a writing direction, a calculating unit configured to calculate a writing speed of each of the plurality of small regions by using a linear programming and a writing unit configured to write a desired pattern in each of the plurality of small regions at the writing speed calculated for each of the plurality of small regions by using a charged particle beam.

### CROSS-REFERENCE TO RELATED APPLICATION

This application is based upon and claims the benefit of priority from the prior Japanese Patent Application No. 2007-198331 filed on Jul. 31, 2007 in Japan, the entire contents of which are incorporated herein by reference.

### BACKGROUND OF THE INVENTION

1. Field of the Invention

The present invention relates to a charged particle beam writing apparatus and a method thereof, and more particularly relates to a writing apparatus that computes an optimal writing speed in writing a pattern in a stripe divided into blocks at a variable writing speed, and to a method thereof.

2. Description of Related Arts

A lithography technique that advances microminiaturization of semiconductor devices is an extremely important process only which forms patterns in semiconductor manufacturing processes. In recent years, with high integration of large-scale integrated circuits (LSI), a circuit critical dimension required for semiconductor devices becomes minuter year by year. In order to form a desired circuit pattern on semiconductor devices, there is required a master pattern (also called a mask or a reticle) of high precision. The electron beam writing technique intrinsically has excellent resolution and is used for manufacturing a highly precise master pattern.

FIG. 6 shows a schematic diagram illustrating operations of a variable-shaped type electron beam (EB) writing apparatus. As shown in the figure, the variable-shaped electron beam writing apparatus includes two aperture plates and operates as follows: A first or “upper” aperture plate 410 has a rectangular opening or “hole” 411 for shaping an electron beam 330. This shape of the rectangular opening may also be a square, a rhombus, a rhomboid, etc. A second or “lower” aperture plate 420 has a variable-shaped opening 421 for shaping the electron beam 330 that passed through the opening 411 into a desired rectangular shape. The electron beam 330 being emitted from a charged particle source 430 and having passed through the opening 411 is deflected by a deflector to penetrate a part of the variable-shaped opening 421 and thereby to irradiate a target workpiece or “sample” 340 mounted on a stage continuously moving in one predetermined direction (e.g. x direction) during the writing or “drawing”. In other words, a rectangular shape capable of passing through both the opening 411 and the variable-shaped opening 421 is written in the writing region of the target workpiece 340 on the stage. This method of writing or “forming” a given shape by letting beams pass through both the opening 411 and the variable-shaped opening 421 is referred to as a “variable shaping” method.

In this case, the electron beam writing apparatus, whose writing region is divided into strip-like frames (or called stripes), continuously performs writing with regarding the frame as a writing unit. Then, when writing, there is a method of dividing the frame into blocks of a fixed or given length, calculating a stage speed for each block, and writing a pattern at the slowest stage speed (e.g., refer to Japanese Patent Application Laid-open No. 2000-21747 (JP-A-2000-21747)). That is, according to the method, writing is performed while the stage is moving in a frame at a uniform speed.

However, since a pattern density in each block is different from each other, the number of shots of electron beams for each block is also different from each other. Therefore, it is inefficient if all the blocks are written at the same speed. Then, writing at an adjustable stage speed in each block becomes required. However, conventionally, the method of optimizing the stage speed in each block has not been established.

In addition, although it is not related to a variable shaping type writing apparatus, there is disclosed a stage speed adjustment in an apparatus for exposing a mask pattern onto a wafer by irradiating electron beams to the mask on which the pattern is formed (e.g., refer to Japanese Patent Application Laid-open No. 2000-49086 (JP-A-2000-49086)).

As mentioned above, although it is requested to perform writing at a variable or “adjustable” stage speed in each block (small region), namely at a variable writing speed, the method of optimizing the speed has not been established.

### BRIEF SUMMARY OF THE INVENTION

It is an object of the present invention to provide a writing apparatus and method thereof whose writing speed of each small region when performing writing at a speed variable in each small region is more suitable when compared with the conventional one.

In accordance with one aspect of the present invention, a charged particle beam writing apparatus includes a dividing unit configured to virtually divide a writing region of a target workpiece into a plurality of small regions, along a writing direction, a calculating unit configured to calculate a writing speed of each of the plurality of small regions by using a linear programming, and a writing unit configured to write a desired pattern in each of the plurality of small regions at the writing speed calculated for each of the plurality of small regions by using a charged particle beam.

In accordance with another aspect of the present invention, a charged particle beam writing method includes virtually dividing a writing region of a target workpiece into a plurality of small regions, along a writing direction, calculating a writing speed of each of the plurality of small regions by using a linear programming, and writing a desired pattern in each of the plurality of small regions at the writing speed calculated for each of the plurality of small regions by using a charged particle beam.

### BRIEF DESCRIPTION OF THE DRAWINGS

FIG. 1 is a schematic diagram showing a structure of a writing apparatus according to Embodiment 1;

FIG. 2 illustrates a state of stage movement according to Embodiment 1;

FIG. 3 is a flowchart showing main steps of a writing method according to Embodiment 1;

FIG. 4 shows an example of a stripe which is divided into blocks according to Embodiment 1;

FIG. 5 shows an example of the block speed according to Embodiment 1; and

FIG. 6 shows a schematic diagram illustrating operations of a conventional variable-shaped type electron beam writing apparatus.

### DETAILED DESCRIPTION OF THE INVENTION

In the following Embodiment, a structure utilizing an electron beam as an example of a charged particle beam will be described. The charged particle beam is not limited to the electron beam, but may be a beam using other charged particle, such as an ion beam.

### EMBODIMENT 1

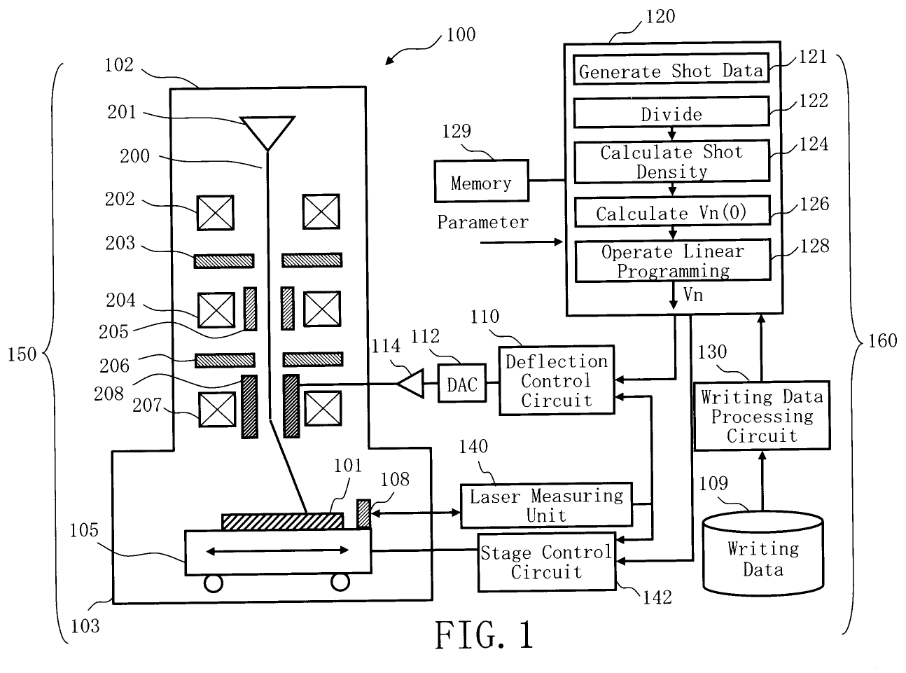

FIG. 1 is a schematic diagram showing a structure of a writing apparatus described in Embodiment 1. In FIG. 1, a pattern writing apparatus 100 includes a writing unit 150 and a control unit 160. The pattern writing apparatus 100 serves as an example of a charged particle beam writing apparatus. The pattern writing apparatus 100 writes a desired pattern onto a target workpiece 101. The control unit 160 includes a magnetic disk device 109, a deflection control circuit 110, a digital analog converter (DAC) 112, an amplifier 114, a control computer 120, a memory 129, a writing data processing circuit 130, a laser measuring unit 140, and a stage control circuit 142. The writing unit 150 includes an electron lens barrel 102 and a writing chamber 103. In the electron lens barrel 102, there are arranged an electron gun assembly 201, an illumination lens 202, a first aperture plate 203, a projection lens 204, a deflector 205, a second aperture plate 206, an objective lens 207, and a deflector 208. In the writing chamber 103, there is an XY stage 105 which is movably arranged. On the XY stage 105, there are placed a mirror 108 and the target workpiece 101. As the target workpiece 101, for example, an exposure mask for exposing or “transferring and printing” a pattern onto a wafer is included. This mask includes a mask blank where no patterns are formed, for example. Moreover, writing data is stored in the magnetic disk device 109. In the control computer 120, processing of functions of a shot data generating unit 121, a dividing unit 122, a shot density calculating unit 124, an initial block speed calculating unit 126, and a linear programming operation unit 128 is performed. The linear programming operation unit 128 is an example of a calculating unit. Input/output or calculated data in the control computer 120 is stored in the memory 129 each time. While only the structure elements necessary for explaining Embodiment 1 are shown in FIG. 1, it should be understood that other structure elements generally necessary for the pattern writing apparatus 100 are also included.

Although processing of functions of the shot data generating unit 121, the dividing unit 122, the shot density calculating unit 124, the initial block speed calculating unit 126, and the linear programming operation unit 128 is executed in the control computer 120 serving as an example of a computer, it is not restricted thereto. It may be executed by hardware, such as an electric circuit. Alternatively, it may be executed by a combination between hardware of an electric circuit and software, or a combination of hardware and firmware.

The writing data processing circuit 130 reads writing data from the magnetic disk device 109, performs merge processing of chips, namely merging a plurality of chips into one chip, and converts the data into a format to be input into the control computer 120. The converted data is sent to the shot data generating unit 121 to generate data to be input into the hardware of the pattern writing apparatus 100, that is shot data in this case. Moreover, in the control computer 120, dividing into blocks and calculating the stage speed V of the XY stage 105 are performed. The shot data is output to the deflection control circuit 110. The deflection control circuit 110 controls the deflector 208 through the DAC 112 and the amplifier 114. While not shown, the deflector 205 is controlled similarly. A stage speed V, a block size, etc. are sent to the stage control circuit 142. Then, the stage control circuit 142 controls the speed and the position of the XY stage 105 based on such data. The position of the XY stage 105 is measured based on a laser beam emitted from the laser measuring unit 140 and a reflected light reflected by the mirror 108.

An electron beam 200 emitted from the electron gun assembly 201, being an example of an irradiation unit, irradiates the whole of the first aperture plate 203 having a rectangular opening by using the illumination lens 202. The electron beam 200 is shaped to be a rectangle. Then, after having passed through the first aperture plate 203, the electron beam 200 of a first aperture image is projected onto the second aperture plate 206 by the projection lens 204. The position of the first aperture image on the second aperture plate 206 is controlled by the deflector 205, and thereby the shape and size of the beam can be changed. That is, the electron beam 200 is formed. After having passed through the second aperture plate 206, the electron beam 200 of a second aperture image is focused by the objective lens 207 and deflected by the deflector 208, to reach a desired position on the target workpiece 101 placed on the XY stage 105 which moves continuously.

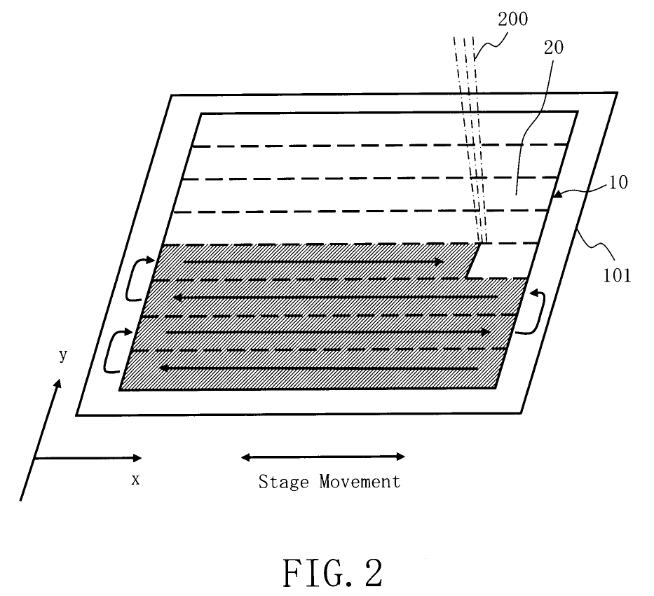

FIG. 2 illustrates a state of a stage movement described in Embodiment 1. When writing on the target workpiece 101, the electron beam 200 irradiates one stripe 20 of the target workpiece 101, made by virtually dividing the writing (exposure) region 10 into a plurality of strip-like stripes (frames) 20 whose width is deflectable, while the XY stage 105 is continuously moving in the x direction, for example. The movement of the XY stage 105 in the X direction is a continuous movement, and simultaneously, the shot position of the electron beam 200 is made to be in accordance with the movement of the stage by the deflector 208. Writing time can be shortened by performing the continuous movement. After writing one stripe 20, the XY stage 105 is moved in the Y direction by step feeding. Then, the writing operation of the next stripe 20 is performed in the X direction (reverse direction). By performing the writing operation of each stripe 20 in a zigzag manner, the movement time of the XY stage 105 can be shortened.

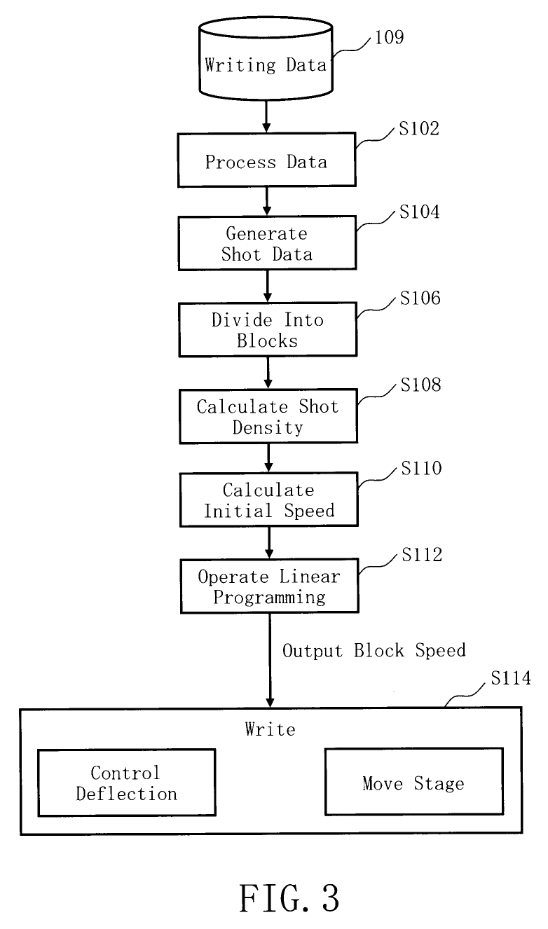

FIG. 3 is a flowchart showing main steps of a writing method described in Embodiment 1. In FIG. 3, the writing method according to Embodiment 1 executes a series of steps: a writing data processing step (S102), a shot data generating step (S104), a block dividing step (S106), a shot density calculating step (S108), an initial block speed calculating step (S110), a linear programming operation step (S112), and a writing step (S114).

In the step S102, as a writing data processing step, the writing data processing circuit 130 reads the writing data for one stripe from the magnetic disk device 109. Then, the writing data processing circuit 130 processes the read writing data and converts it into data of a format used in the apparatus for the next shot data generation step. Coordinates indicating the position of a figure to be written, the figure code and figure size indicating the figure, etc. are defined in the writing data. The converted data is output to the control computer 120.

In the step S104, as a shot data generating step, the shot data generating unit 121 inputs the data converted from the writing data and generates data, namely shot data in this case, to be input into the writing unit 150, based on the writing data.

In the step S106, as a block dividing step, the dividing unit 122 virtually divides the stripe (writing region) 20 of the target workpiece 101 into a plurality of blocks (small regions) along the writing direction.

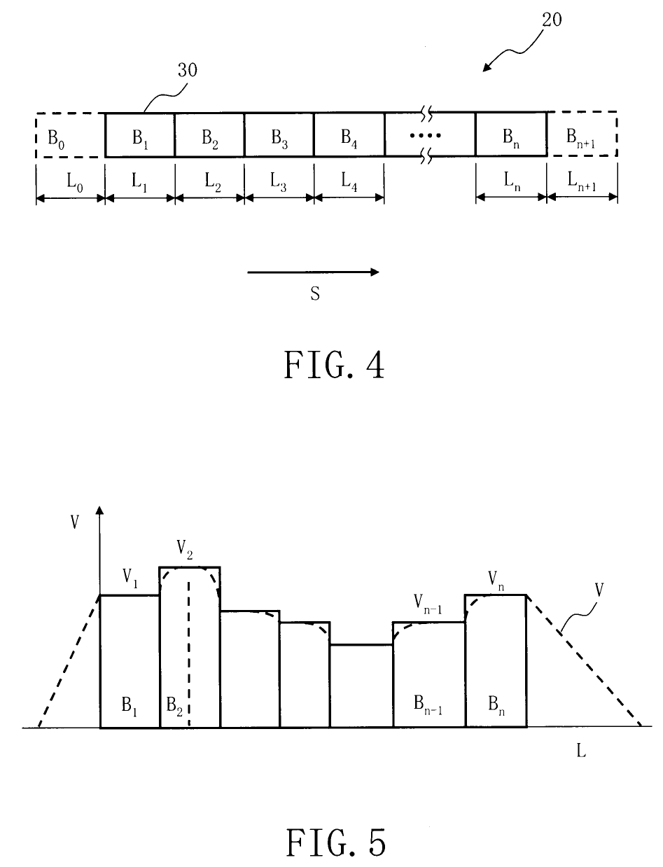

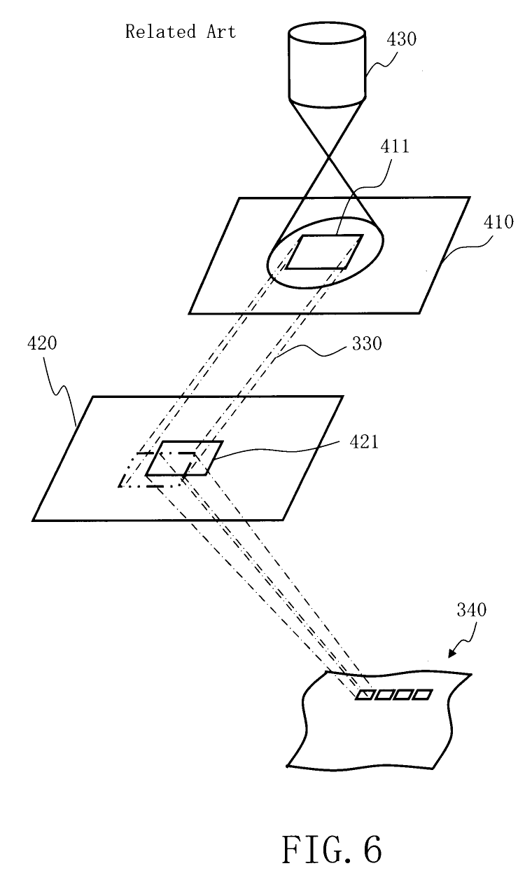

FIG. 4 shows an example of a stripe which is divided into blocks according to Embodiment 1. In FIG. 4, the stripe 20 is virtually divided into a plurality of blocks 30 each having a fixed or given length Lᵢ along the writing direction S.

In the step S108, as a shot density calculating step, the shot density calculating unit 124 calculates a shot density ρₛₕₒₜ₍ᵢ₎ for each block 30.

In the step S110, as an initial block speed calculating step, the initial block speed calculating unit 126 calculates an initial block speed Vᵢ₍₀₎ (initial writing speed) for each block 30. The initial block speed Vᵢ₍₀₎ can be obtained by the following equations (1-1) to (1-3).

$$\begin{matrix}{V}_{i ( 0 )} = \frac{1}{( {ρ}_{shot ( i )} \cdot {t}_{cycle} + {ρ}_{SF} \cdot {t}_{SF} ) \cdot {w}_{y}} & ( 1 \text{-} 1 ) \\ {t}_{cycle} = \frac{D}{N \cdot J} + {t}_{shot ( stt ) \\} & ( 1 \text{-} 2 ) \\ {ρ}_{shot ( i )} = {( \frac{1000}{s} )}^{2} & ( 1 \text{-} 3 )\end{matrix}$$

As parameters in the equations (1-1) to (1-3), there exist a stripe height w_{y} in the y-direction, a multi-pass count N, an amount of beam irradiation (dose) D, a current density J, a subfield (SF) dimension s, a shot settling time tₛₕₒₜ₍ₛₜₜ₎, an SF settling time t_{SF}, and a shot density ρₛₕₒₜ₍ᵢ₎.

In the step S112, as a linear programming operation step, the linear programming operation unit 128 calculates a block speed Vᵢ (writing speed) of each of a plurality of blocks (small regions) by using a linear programming. The linear programming operation unit 128 calculates the block speed Vᵢ of each block 30 by using an initial block speed Vᵢ₍₀₎ of each block 30, a length Lᵢ of each block 30, a permissible acceleration g, and a fixed acceleration time Ts (predetermined acceleration time).

Since the acceleration cannot be increased beyond a certain value in the pattern writing apparatus 100, there is a case where it is impossible to reach a desired speed in moving in the blocks 30 by using the initial block speed Vᵢ₍₀₎. Moreover, changing the speed of a certain block 30 will affect the speed of other blocks. Then, in Embodiment 1, in order to let the writing speed of a given stripe 20 be the fastest, optimization of the block speed Vᵢ of each block 30 is performed by the following method.

FIG. 5 shows an example of the block speed according to Embodiment 1. In FIG. 5, the solid line bar graph shows a block speed Vᵢ which is set for each block 30. The dotted line shows an actual speed change. Moreover, as shown in FIG. 5, considering the block speed V₁ of the starting block B₁, a block B₀ of a suitable length L₀ shown in FIG. 4 is added in order to accelerate from the initial speed 0 (zero) to the block speed V₁ by using the permissible acceleration g. Similarly, considering the block speed Vₙ of the ending block Bₙ, a block Bₙ₊₁ of a suitable length Lₙ₊₁ shown in FIG. 4 is added in order to slow down from the block speed V₁ to the speed 0 (zero) by using the permissible acceleration g. For the reason of speed calculation, only acceleration or slowdown is performed in one block 30. Therefore, the maximum block (block B₂ in FIG. 5) whose block speed is the maximum is divided into two at the middle point or a given point to virtually treat as two blocks.

Although a nonlinear relation exists among the block length Lᵢ, the block speed Vᵢ and the block speed Vᵢ₋₁ in the block Bᵢ, Taylor expansion is performed using the initial block speed Vᵢ₍₀₎ and the initial block speed Vᵢ₋₁₍₀₎ to approximate by the following equations (2-1) to (2-n). While writing, calculating the block speed Vᵢ takes much time in the nonlinear relation. However, it becomes possible to calculate the block speed Vᵢ in real time by calculating as follows:

$$\begin{matrix}\frac{1}{2 g} ( ( {V}_{1 ( 0 )}^{2} - {V}_{0 ( 0 )}^{2} ) - 2 {V}_{0 ( 0 )} ( {V}_{0} - {V}_{0 ( 0 )} ) + 2 {V}_{1 ( 0 )} ( {V}_{1} - {V}_{1 ( 0 )} ) ) + \frac{1}{2} Ts ( {V}_{1} + {V}_{0} ) \leq {L}_{1} & ( 2 \text{-} 1 ) \\ \frac{1}{2 g} ( ( {V}_{2 ( 0 )}^{2} - {V}_{1 ( 0 )}^{2} ) - 2 {V}_{1 ( 0 )} ( {V}_{1} - {V}_{1 ( 0 )} ) + 2 {V}_{2 ( 0 )} ( {V}_{2} - {V}_{2 ( 0 )} ) ) + \frac{1}{2} Ts ( {V}_{2} + {V}_{1} ) \leq {L}_{2} & ( 2 \text{-} 2 ) \\ \frac{1}{2 g} ( ( {V}_{n ( 0 )}^{2} - {V}_{n - 1 ( 0 )}^{2} ) - 2 {V}_{n - 1 ( 0 )} ( {V}_{n - 1} - {V}_{n - 1 ( 0 )} ) + 2 {V}_{n ( 0 )} ( {V}_{n} - {V}_{n ( 0 )} ) ) + \frac{1}{2} Ts ( {V}_{n} + {V}_{n - 1} ) \leq {L}_{n} & ( 2 \text{-} n )\end{matrix}$$

A block speed Vᵢ by which ΣVᵢ/Lᵢ becomes the maximum is calculated by a linear programming method, regarding the first condition which satisfies all n equations of the equations (2-1) to (2-n) and the second condition which satisfies Vᵢ≦Vᵢ₍₀₎, meaning that the block speed Vᵢ should not exceed the initial block speed Vᵢ₍₀₎, as constraint conditions. That ΣVᵢ/Lᵢ becomes the maximum means the same as that the writing time for writing all the plurality of blocks 30 becomes shorter. By performing the calculation described above, an optimized block speed Vᵢ satisfying the constraint conditions can be obtained. The optimized block speed Vᵢ can be used as the stage speed of each block 30.

As mentioned above, it is possible to compute a more suitable writing speed for each small region by using a linear programming.

Since the block B₀ serving as a run-up acceleration section is virtually added, if it can be performed within the acceleration time Ts, the block speed V₁ can be set to the initial block speed V₁₍₀₎ which is the maximum speed.

In the step S114, as a writing step, the writing unit 150 writes a desired pattern in each block 30 at the calculated block speed Vᵢ of each block 30, using the electron beam 200. That is, the stage control circuit 142 controls the XY stage 105 to move at the block speed Vᵢ. In accordance with this, the deflection control circuit 110 controls the deflector 208 through the DAC 112 and the amplifier 114.

As mentioned above, according to the present Embodiment, the writing speed can be more suitable. Therefore, total writing time can be shortened, and thereby the throughput can be increased.

In the above description, what is represented as the “unit” or “step” can be configured by computer programs. They may be implemented by software programs executed by the computer system. Alternatively, they may be executed by a combination of software and hardware, or a combination of software, hardware and/or firmware. When constituted by a program, the program is stored in a computer-readable recording medium, such as a magnetic disk drive, magnetic tape drive, FD, CD, DVD, MO or ROM. For example, programs are stored in the memory 129. Alternatively, it is sufficient at least one of the recording media is connected to the control computer 120 or installed in the control computer 120.

While the embodiments have been described above with reference to specific examples, the present invention is not restricted to these specific ones.

While description of the apparatus structure, control method, etc. not directly required for explaining the present invention is omitted, it is possible to suitably select and use some or all of them when needed. For example, although the structure of the control unit for controlling the pattern writing apparatus 100 is not described, it should be understood that a necessary control unit structure can be selected and used appropriately.

In addition, any other charged particle beam writing apparatus and method thereof that include elements of the present invention and that can be appropriately modified by those skilled in the art are included within the scope of the present invention.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A charged particle beam writing apparatus comprising:
a dividing unit configured to virtually divide a writing region of a target workpiece into a plurality of small regions, along a writing direction;
a calculating unit configured to calculate a writing speed of each of the plurality of small regions by using a linear programming; and
a writing unit configured to write a desired pattern in each of the plurality of small regions at the writing speed calculated for each of the plurality of small regions by using a charged particle beam.

2. The apparatus according to claim 1, wherein, in the plurality of small regions, the writing speed of a first small region of the plurality of small regions is set at an initial writing speed of the first small region.

3. The apparatus according to claim 1, wherein the calculating unit calculates the writing speed of each of the plurality of small regions so that a writing time for writing all of the plurality of small regions is shorter than the writing time for writing all of the plurality of small regions by using another writing speed of each of the plurality of small regions, and so that the writing speed of each of the plurality of small regions does not exceed an initial writing speed of a corresponding small region of the plurality of small regions.

4. The apparatus according to claim 3, wherein, in the plurality of small regions, the writing speed of a first small region of the plurality of small regions is set at an initial writing speed of the first small region.

5. The apparatus according to claim 1, wherein the calculating unit calculates the writing speed of each of the plurality of small regions by using an initial writing speed of a corresponding small region of the plurality of small regions, a length of the corresponding small region of the plurality of small regions, a permissible acceleration, and a predetermined acceleration time.

6. The apparatus according to claim 5, wherein, in the plurality of small regions, the writing speed of a first small region of the plurality of small regions is set at an initial writing speed of the first small region.

7. The apparatus according to claim 5, wherein the calculating unit calculates the writing speed of each of the plurality of small regions so that a writing time for writing all of the plurality of small regions is shorter than a writing time for writing all of the plurality of small regions by using another writing speed of each of the plurality of small regions, and so that the writing speed of each of the plurality of small regions does not exceed an initial writing speed of a corresponding small region of the plurality of small regions.

8. The apparatus according to claim 7, wherein, in the plurality of small regions, the writing speed of a first small region of the plurality of small regions is set at an initial writing speed of the first small region.

9. A charged particle beam writing method comprising:
virtually dividing a writing region of a target workpiece into a plurality of small regions, along a writing direction;
calculating a writing speed of each of the plurality of small regions by using a linear programming; and
writing a desired pattern in each of the plurality of small regions at the writing speed calculated for each of the plurality of small regions by using a charged particle beam.

10. The method according to claim 9, wherein the writing speed of each of the plurality of small regions is calculated by using an initial writing speed of a corresponding small region of the plurality of small regions, a length of the corresponding small region of the plurality of small regions, a permissible acceleration, and a predetermined acceleration time.
